(19) United States
(12) Patent Application Publication
(10) Pub. No.: US 2022/0381311 A1
(43) Pub. Date: Dec. 1, 2022

(54) WAVE COIL SPRING AND METHOD FOR ADDITIVELY MANUFACTURING THEREOF

(71) Applicant: National Taiwan University of Science and Technology, Taipei (TW)

(72) Inventors: Jeng-Ywan Jeng, Taipei (TW); Aamer Nazir, Taipei (TW); Muhammad Rizwan ul Haq, Taipei (TW)

(21) Appl. No.: 17/323,217

(22) Filed: May 18, 2021

(51) Int. Cl. F16F 1/32; F16F 3/02

(52) U.S. Cl. CPC F16F 1/328; F16F 3/02

(57) ABSTRACT

A wave spring unit comprising a plurality of annular wave-spring elements stacked vertically along an axial direction, which is characterized in that each of the annular wave spring elements of the wave spring unit comprises crest portion and trough portion formed alternately in a horizontal axial direction; said crest portion and trough portion of adjacent vertically annular wave spring elements are positioned opposite each other; said adjacent vertically annular wave spring elements have the same or different from each other in at least one physical parameter selected form a strip thickness, a strip diameter, a strip weight, strip shape, wave contact number, edge shape, overall shape of the spring and a combination of wave and helical spring; and the wave spring unit has a maximum compression up to 30.2 mm and is capable of bearing load up to 2680.2 N.

### BACKGROUND OF THE INVENTION

### Technical Field

The invention relates to a wave spring made by additive manufacturing process, particularly to a wave spring with variable dimensions that has much higher performance in load bearing, stress strain properties, energy absorption and energy release as compared to both uniform dimensions and uniform shaped wave springs.

### Background

Springs are used to absorb energy and give a damping effect in the structures. In this regard, wave springs are quite unique and have number of advantages over the common springs (helical, taper etc.) such as:
1. Wave springs reduce spring height by 50%.
2. Absorb more energy and ultimately provide more damping effect than the common springs (helical springs).
3. Fit tight radial and axial spaces.

Wave spring has unique design and shorter in length than the helical springs but having the same mechanical properties due to which it has more potential applications. For examples, wave springs can be used in a number of applications such as bio-medical for intervertebral prosthesis, in mattresses, frictional dampers, athletic shoes, lock washer replacement, aerospace electrical connectors, flow valve applications, pressure relief valves and seals.

In US 20050126039 A1, it discloses a spring cushioned shoe for athletic shoes which were designed for high impact sports such as volleyball and basketball. In US20090292363, it discloses an intervertebral prosthesis in which wave springs are used in spinal implant.

All of these existing wave springs are non-contact wave springs, manufactured by the traditional methods as these were never manufactured by additive manufacturing method. Specifically, such existing wave springs are simple in design but have low performance because of sliding and slipping of helixes from each other under compression.

In view of forgoing, it is required to manufacture more complex designs with variable geometric shapes. Especially, it is preferably desired to design a contact and non-contact wave springs that has variable dimensions in different geometric shapes and excellent performance of mechanical properties and manufacture it by polymers instead of structural steel using an additive manufacturing method.

### SUMMARY OF THE INVENTION

Therefore, in view of the deficiencies in the prior study, the inventor through careful research, numbers experimentation and perseverance spirit, finally accomplished the present invention to solve the shortcomings of the prior studies.

Namely, the object of the present invention is to provide a wave spring unit comprising a plurality of annular wave-spring elements stacked vertically along an axial direction, which is characterized in that the wave spring unit is configured to have a shaped longitudinal section in the front view comprising rectangular profile, variable-width profile, variable-thickness profile, fillet edges profile, non-contact profile, flat strip profile, variable width profile, elliptical profile, taper profile, round profile, overall shape of the spring or spring in spring profile; each of the annular wave spring elements comprises crest portion and trough portion formed alternately in a horizontal axial direction, in which the crest portion abuts the trough portion; said crest portion and trough portion of adjacent vertically annular wave spring elements are positioned opposite each other; said adjacent vertically annular wave spring elements have the same or different from each other in at least one physical parameter selected form a strip thickness, a strip diameter, a strip weight, strip shape, wave contact number, edge shape, overall shape of spring and a combination of wave and helical spring; and the wave spring unit has a maximum compression up to 30.2 mm and is capable of bearing load up to 2680.2 N, when a load imposed on said annular wave spring unit and a deflection produced in said annular wave spring unit by the imposition of said load.

In a particular embodiment, each of the annular wave spring elements is configured to have a thickness-diameter ratio of a thickness over a diameter ranging from 0.05 to 1.05.

In a particular embodiment, which is configured to have a shaped longitudinal section of rectangular profile in the front view, have a maximum compression up to 25.6 mm and be capable of bearing load up to 124.3 N.

In a particular embodiment, which is configured to have a shaped longitudinal section of variable-thickness profile in the front view, have a maximum compression up to 22.2 mm and be capable of bearing load up to 193.3 N.

In a particular embodiment, which is configured to have a shaped longitudinal section of fillet edges profile in the front view, have a maximum compression up to 25.6 mm and be capable of bearing load up to 103.3 N.

In a particular embodiment, which is configured to have a shaped longitudinal section of non-contact profile in the front view, have a maximum compression up to 22.7 mm and be capable of bearing load up to 68.0 N.

In a particular embodiment, which is configured to have a shaped longitudinal section of flat strip profile in the front view, have a maximum compression up to 30.2 mm and be capable of bearing load up to 213.5 N.

In a particular embodiment, which is configured to have a shaped longitudinal section of variable-width profile in the front view, have a maximum compression up to 21.8 mm and be capable of bearing load up to 126.8 N.

In a particular embodiment, which is configured to have a shaped longitudinal section of elliptical profile in the front view, have a maximum compression up to 24.5 mm and be capable of bearing load up to 273.3 N.

In a particular embodiment, which is configured to have a shaped longitudinal section of taper profile in the front view, have a maximum compression up to 18.9 mm and be capable of bearing load up to 660.6 N.

In a particular embodiment, which is configured to have a shaped longitudinal section of round profile in the front view, have a maximum compression up to 13.7 mm and be capable of bearing load up to 514.5 N.

In a particular embodiment, which is configured to have a shaped longitudinal section of spring-in-spring profile in the front view, have a maximum compression up to 25.1 mm and be capable of bearing load up to 2680.2 N.

In a particular embodiment, which is configured to have a shaped longitudinal section of rectangular profile in the front view, comprising a fillet in each corner; wherein the fillet has an inclined angle of 45° with respect to the axial direction.

In a particular embodiment, wherein each of the annular wave spring elements is configured to have an identical diameter.

In a particular embodiment, wherein each of the annular wave spring elements is configured to have a different diameter.

In a particular embodiment, the annular wave spring unit is configured to have a maximum diameter-height ratio of a total height over a maximum diameter among the annular wave spring elements ranging from 0.2 to 0.5.

In a particular embodiment, wherein the annular wave spring unit have a minimum diameter-height ratio of a total height over a minimum diameter among the annular wave spring elements ranging from 0.2 to 0.5.

In a particular embodiment, wherein the annular wave-spring unit has a ratio of wire diameter over average diameter ranging from 0.01 to 0.1, in which wire diameter is the maximum diameter among all of the circular cross sections and the average diameter is calculated from each diameter of the annular wave spring elements measured along a radial direction perpendicular to the axial direction.

In a particular embodiment, wherein each of the annular wave spring elements is configured to have an identical diameter.

In a particular embodiment, wherein each of the annular wave spring elements is configured to have a different diameter.

In a particular embodiment, the annular wave spring unit is configured to have a maximum diameter-height ratio of a total height over a maximum diameter among the annular wave spring elements ranging from 0.2 to 0.5.

In a particular embodiment, wherein the annular wave spring unit have a minimum diameter-height ratio of a total height over a minimum diameter among the annular wave spring elements ranging from 0.2 to 0.5.

In a particular embodiment, which is made by an additive manufacturing process.

In a particular embodiment, wherein the additive manufacturing process is processed by means of at least one selected from a group consisting of selective laser melting (SLM), selective laser sintering (SLS), multie jet fusion (MJF), polyjet, electron beam melting (EBM), laser metal forming (LMF), laser engineered net shape (LENS), and direct metal deposition (DMD).

### BRIEF DESCRIPTION OF THE DRAWINGS

FIG. 1a shows illustrative parameters of wave spring in Design for Additive Manufacturing (DfAM).

FIG. 1b shows an illustrative nomenclature of spring of different terminology of wave spring.

FIGS. 2a to 2j separately depict various types of wave spring units according to the present invention.

FIG. 3A shows a graph of comparison for wave spring units 1 to 10 in compression tests.

FIG. 3B shows a graph of comparison for wave spring units 1 to 10 in loading-unloading tests.

### DETAILED DESCRIPTION OF THE PREFERRED EMBODIMENTS

In order to improve clearer understanding the technical features, objectives and effects of the present invention, some specific embodiments will now be described in details with reference to illustrated drawings annexed herewith. The detailed description and technical contents of the present invention are described as follows in conjunction with the drawings. However, the drawings are only provided for reference and explanation, and are not used to limit the creation.

In addition, regarding the foregoing and other technical contents, features and effects of the present invention, it will be clearly presented in the detailed description of each embodiment with reference to the drawings. The directional terms mentioned in the following embodiments, for example: “up ”, “down”, “left”, “right”, “front”, “rear”, etc., are just for reference to the directions shown in attached drawings.

Furthermore, in the following embodiments, the same or similar elements will be denoted by using the same or similar element numbers. In addition, the terms “first” and “second” mentioned in this specification or claims are only used to name the element or to distinguish different embodiments or ranges and are not used to express the Upper or lower limit in the number of elements.

The wave spring unit of the present invention comprises a plurality of annular wave-spring elements stacked vertically along an axial direction. Each of the annular wave spring elements comprises crest portion and trough portion formed alternately in a horizontal axial direction, in which the crest portion abuts the trough portion; said crest portion and trough portion of adjacent vertically annular wave spring elements are positioned opposite each other. And the adjacent vertically annular wave spring elements have the same or different from each other in at least one physical parameter selected form a strip thickness, a strip diameter, a strip weight, strip shape, wave contact number, edge shape and a combination of wave and helical spring.

The wave spring unit of the present invention is designed to create a topology optimization (TO) parts by Design for Additive Manufacturing (DfAM)as TO is an efficient method which calculates the optimal material distribution for a structure without effecting its mechanical properties, and DfAM enables the necessary changes in the design by removing the material from lower stress concentration areas and add that material to high concentration areas to keep the overall material distribution constant.

In the present invention, contact and non-contact wave springs were designed by using solidworks (Dassault Systems SolidWorks Corporation, US).

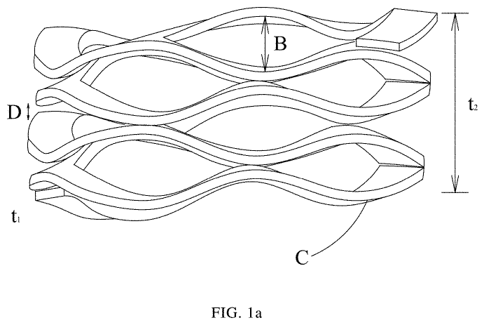

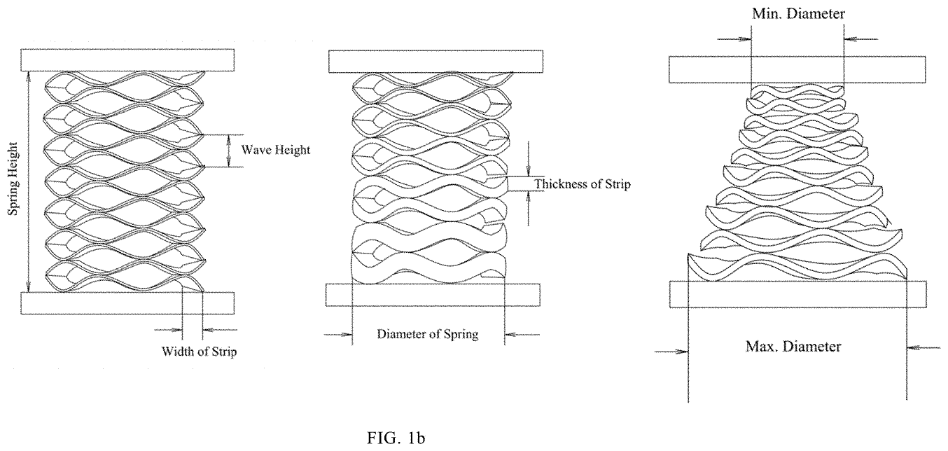

DfAM for non-contact wave spring controlled by the three parametric equations Eq. 1, Eq. 2 and Eq. 3 which were written in equation drive curve module in solidworks for the path sketch for the sweep command which will define the 3D curve for the shape of the wave spring (modeling a wave spring in solidworks>engineering.com,), also shown in FIG. 1a.

X=A*sin(t) Eq. 1

Y=A*cos(t) Eq. 2

Z=B*sin(C*t)+D*(t) Eq. 3

Wherein,

A=Outer Radius of the spring

C=Number of Waves

D=Space Between Curves

“C” Must be non-Integer of ¹/₂ e.g. 0.5, 1.5, 2.5

B=Amplitude/Pitch

Better to take D as half of B.

t1=0 (Initial point)

t2=Desired Spring Length

After defining the path i.e., 3D curve, used the sweep command to get the final shape.

Contact wave springs were designed manually by defining a circle having the diameter equal to the diameter of the wave spring, divided the circle in ten equally distant points and used derived sketch command. The points were joined by 3D sketch curved to define the path for sweep command.

The difference of DfAM for variable dimension wave springs, was the swept profile with variable dimensions in terms of internal and outer diameter, thickness of strip, width of strip while the wave springs with variable geometric (taper, cylindrical, elliptical, variable width, variable thickness) were designed by defining variable diameter of each helix.

Finally, assemble the helixes by using assembly command and defining the surface-to-surface contact between the helixes. By utilizing the advancement of DfAM, springs in spring structure was designed by providing helical springs in between the helixes of wave spring. The nomenclature of spring of different terminology of wave spring is illustrated in FIG. 1b.

Further, according to the invention, the wave spring units can be designed by various parameters approach for designing of variable-dimension and uniform-dimension to acquire desired mechanical properties.

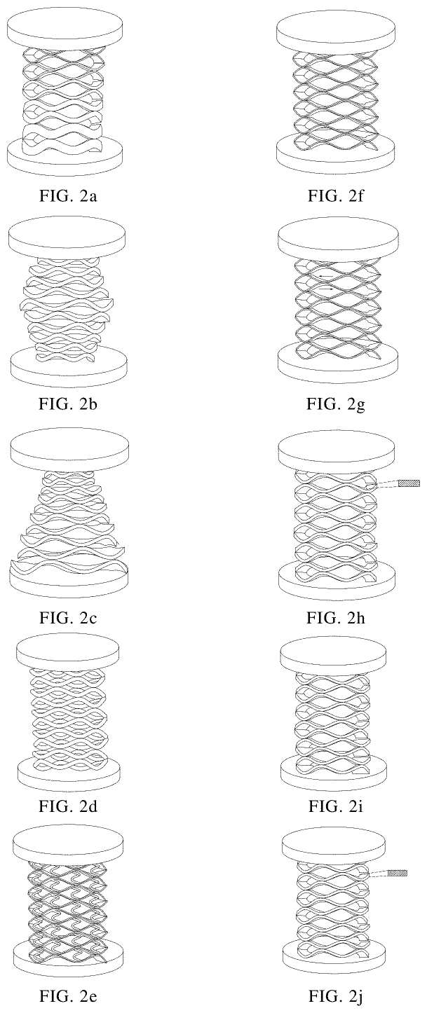

Please refer to FIGS. 2a to 2j, which separately depict various types of wave spring units according to the present invention. The wave spring unit preferably is configured to have a shaped longitudinal section in the front view comprising variable thickness profile as shown on FIG. 2a, elliptical profile as shown on FIG. 2b, taper profile as shown on FIG. 2c, round profile as shown on FIG. 2d, spring in spring profile as shown on FIG. 2e, flat strip profile as shown on FIG. 2f, non-contact profile as shown on FIG. 2g, fillet edges profile as shown on FIG. 2h,variable width rectangular profile as shown on FIG. 2i, or rectangular profile as shown on FIG. 2j. All the springs were manufactured by flat strip except the round wave spring in which round wire was used. Spring height was the total height of the spring which can be calculated by adding height of each helix and thickness of strip for each helix. Maximum and minimum diameter of the springs were defined to design the different geometric shape of wave springs. Diameter, mass and height of each design were kept constant for the comparison of results for all designs.

In the present invention, PA12 (Nylon 12 polymer) material was used to print the parts and properties of this material are shown below.

| Density | Young's modulus | |
|---|---|---|
| (g/cm³) | (MPa) | Poisson's ratio |
| 1.01 | 1250 | 0.33 |

In addition, to investigate the mechanical properties of the load—deflection curves of various springs with the same height, volume fraction, and mass, but variable shapes, some experiments including uniaxial compression and loading—unloading tests were performed to investigate the load-bearing capacity.

The printed samples were tested by MTS Insight universal testing machine (MTS System Corporation, USA) at room temperature. The crosshead speed was 300mm/min which was high for compression testing because to check the energy absorption during loading and energy released during unloading by the springs to retain its original position at high speed which leads to the damping capacity of these designed springs.

To test the wave spring specimens as illustrated in FIGS. 2a to 2j, compressible distance for each wave spring specimen had been calculated by measuring the distance between each helix of each wave spring specimen. Each wave spring has different compressible distance, for example, maximum compression (mm) as recorded in Table 1. For safety and the uniformity of testing, each wave spring specimen has been compressed up to 90 percent of its compressible distance, the wave springs as illustrated in in FIGS. 2a to 2j were not fully (100%) compressed to avoid plastic failure. By calculating the ratio of 90 percent compressible distance to total height, strain end point was calculated for each design which was a prime input value for compression testing machine.

Each wave spring specimen was tested up to 10 cycles of loading/unloading because preliminary study of these designs depicted that they become stable in terms of material setting and load bearing capacity up to 10th cycle.

The calculated stress is based on the cross-sectional area while in variable dimensions wave spring, the least area was considered for the stress calculations as stress will be higher on the smaller areas.

The energy absorbed by each spring is calculated by calculating areas under the loading (energy applied) and energy returned (unloading) curves and substituting the values as shown in Equation 4;

$$Energy loss = \frac{Energy Applied - Energy Returned}{Energy Applied} \times 100 \qquad Eq . 4$$

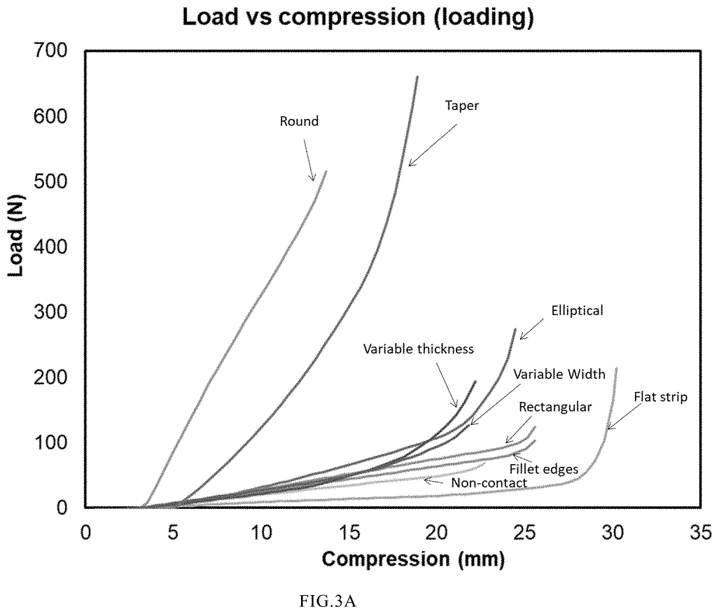

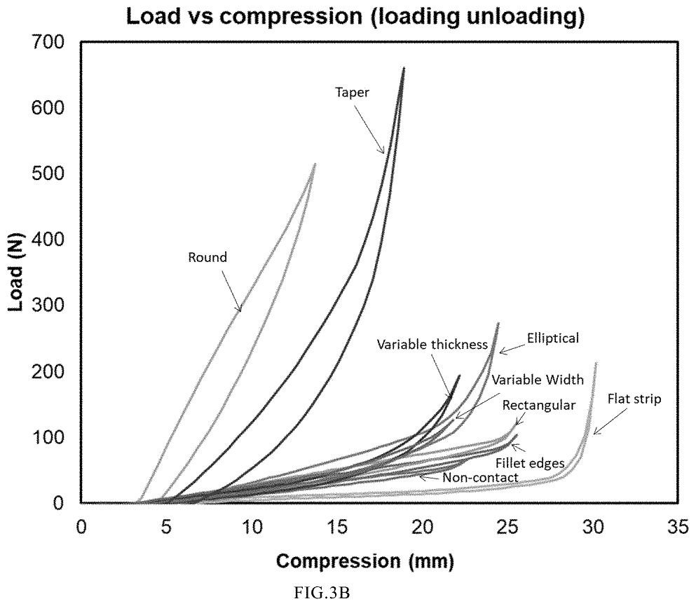

The graphs between load vs. compression presented in FIG. 3A and 3B were based on average value of load and compression results of each wave spring obtained from load vs. compression analysis.

The results of maximum loading and maximum compression were shown on the table 1 below.

TABLE 1
various wave spring units

| | | Spring 1 | Spring 2 | Spring 3 | Spring 4 | Spring 5 |
|---|---|---|---|---|---|---|
| Spring name | | Variable | Elliptical | Taper | Round | Spring in |
| | | thickness | | | | spring |
| Spring Shape | | [symbol] | [symbol] | [symbol] | [symbol] | [symbol] |
| Design | Pitch | 2 | 2 | 2 | 2 | 2 |
| Para- | (mm) | | | | | |
| meters | Wire | 4 | 5 | 5 | 3.1 | 5 |
| | dia. | | | | | |
| | (mm) | | | | | |
| | Mean/ | 35 | Max. 35 | Max. 35 | 35 | 35 |
| | coil | | | | | |
| | dia. | | Min. 21 | Min. 25 | | |
| | (mm) | | | | | |
| | Mass | 17.8 | 17.5 | 17.8 | 17.6 | 17.6 |
| | (grams) | | | | | |
| | | Compression test (mm) | | | | |
| Max. Load (N) | | 196.6 | 273.3 | 660.6 | 514.5 | 2680.2 |
| Max. | | 22.2 | 24.5 | 18.9 | 13.7 | 25.1 |
| Compression | | | | | | |
| (mm) | | | | | | |
| | | Spring 6 | Spring 7 | Spring 8 | Spring 9 | Spring 10 |
| Spring name | | Flat strip | Non- | Fillet | Variable | Rectangular |
| | | | contact | edges | Width | |
| Spring Shape | | [symbol] | [symbol] | [symbol] | [symbol] | [symbol] |
| Design | Pitch | 2 | 2 | 2 | 2 | 2 |
| Para- | (mm) | | | | | |
| meters | Wire | 10 | 5 | 5 | Max. 6 | 5 |
| | dia. | | | | Min. 2.1 | |
| | (mm) | | | | | |
| | Mean/ | 35 | 35 | 35 | 35 | 35 |
| | coil | | | | | |
| | dia. | | | | | |
| | (mm) | | | | | |
| | Mass | 18.5 | 17 | 17.4 | 17.8 | 17.8 |
| | (grams) | | | | | |

Compression test (mm)

| | | | | | |
|---|---|---|---|---|---|
| Max. Load (N) | 213.5 | 68.0 | 103.3 | 193.6 | 124.3 |
| Max. | 30.2 | 22.7 | 25.6 | 22.2 | 25.6 |
| Compression | | | | | |
| (mm) | | | | | |

As shown in Table 1, FIG. 3A and 3B, when the wave spring unit is configured to have a shaped longitudinal section of variable-thickness profile in the front view as shown in FIG. 2a, it has a maximum compression up to 22.2 mm and be capable of bearing load up to 193.3 N. The variable-thickness wave spring has gradual increase in thickness and mass distribution from top to bottom with constant width of each helix. It enables the upper helixes soft while the bottom helixes had more stiffness, and its properties of energy absorption and loss thus are improved.

When wave spring unit is configured to have a shaped elliptical profile with z-axis variation in the front view as shown in FIG. 2b, it has a maximum compression up to 24.5 mm and be capable of bearing load up to 273.3 N. The elliptical wave spring is stiffer as well as had good energy absorbing capacity as the diameter of each helix increases from top and from bottom till center (ellipse shape) which ultimately resulted more mass in the center than the bottom and top. As mass increases the stiffness increases as well, hence this wave spring was stiffer in the middle than the bottom and top. The force transmission was smooth under compression testing for each helix.

When the wave spring unit is configured to have a shaped taper profile with a decreasing diameter in the front view as shown in FIG. 2c, it thus is z-axis variation or y-axis variation and has a maximum compression up to 18.9 mm and be capable of bearing load up to 660.6 N. It represents the conical/taper geometric shape of which the diameter of each helix increases from top to bottom, and thus the taper wave spring can bear maximum load due to which top helixes were under more load as contact area was smaller than the lower helixes to enable smooth transfer of force from top to bottom and enhance the load bearing capacity.

When the wave spring unit is configured to have a shaped longitudinal section of round profile in the front view as shown in FIG. 2d, it has a maximum compression up to 13.7 mm and be capable of bearing load up to 514.5 N. Further, it also shows excellent stiffness and energy absorption/loss property that has improved mechanical properties once the strip to manufacture wave spring was replaced by the round wire.

When the wave spring unit is configured to have a shaped longitudinal section of spring-in-spring profile in the front view as shown in FIG. 2e, it has a maximum compression up to 25.1 mm and be capable of bearing load up to 2680.2 N. As show in Table 1, this spring-in-spring structure has highest load bearing capacity, highest energy absorption, and highest stress value and it can be used where higher energy absorption is required irrespective of plastic deformations.

Further, when the wave spring unit is configured to have a shaped longitudinal section of flat strip profile in the front view as shown in FIG. 2f, it has a maximum compression up to 30.2 mm and be capable of bearing load up to 213.5 N. The flat strip wave spring has uniform width of which each helix has the same mass distribution. The width of each helix is more than any other designed spring. The thickness of each helix is minimum than any other design. This spring's behavior was linear having high energy loss as the aspect ratio (width to thickness) was higher for this spring.

When the wave spring unit is configured to have a shaped longitudinal section of non-contact profile in the front view as shown in FIG. 2g, it has a maximum compression up to 22.7 mm and be capable of bearing load up to 68.0 N. The non-contact wave spring having the helix were not permanently contacted, which results low stiffness of the spring while during the compression testing the helix tends to slide from each other and had lowest load bearing capacity.

When the wave spring unit is configured to have a shaped longitudinal section of fillet edges profile in the front view as shown in FIG. 2h, it has a maximum compression up to 25.6 mm and be capable of bearing load up to 103.3 N. In the filleted corners wave spring, material removed of fillet was distributed to each helix to keep the mass constant. This distribution of extra material improves the properties of this filleted corner and result more stiffness of the spring.

When the wave spring unit is configured to have a shaped longitudinal section of variable width profile in the front view as shown in FIG. 2i, it has a maximum compression up to 21.8 mm and be capable of bearing load up to 126.8 N. The variable width wave spring has the graded width of each helix from top to bottom. This design was better than the uniform width as top helixes absorbs less energy and transfer the force to the lower helixes smoothly.

When the wave spring unit is configured to have a shaped longitudinal section of rectangular profile in the front view as shown in FIG. 2j, it has a maximum compression up to 25.6 mm and be capable of bearing load up to 124.3 N. The rectangular wave spring has constant width and thickness for each helix and the material distribution of the rectangular wave spring is uniform. Hence, the rectangular wave spring has smooth transformation of force and gives moderate properties of energy absorption/loss during compression caused by loading.

In comparison with normal rectangular wave spring which are available and manufactured by traditional manufacturing, springs in spring has the highest load baring capacities as it can bear up to 2500N. Then taper and round wire wave springs which can bear up to 614 N and 500 N respectively. The only embodiments which lower load bearing capacities than the rectangular wave spring are non-contact, fillet corner and flat strip wave spring. Although these have lower load bearing capacities but flat strip wave spring has lowest time to return to its original position in unloading.

In conclusion, it is found that wave springs of variable dimensions with different geometrical shapes designed and additively manufactured successfully according to the invention, have improved mechanical properties significantly such as load bearing capacity, stress, energy return, stiffness characteristics, strain and energy absorption than traditionally manufactured non-contact wave springs.

However, the above are only the preferred embodiments of the present invention and should not be used to limit the scope of implementation of the present invention, that is, the simple equivalents made according to the scope of patent application and description of the invention Changes and modifications are still within the scope of the patent for this invention.

What is claimed is:

1. A wave spring unit comprising a plurality of annular wave-spring elements stacked vertically along an axial direction, which is characterized in that the wave spring unit is configured to have a shaped longitudinal section in the front view comprising rectangular profile, variable-width profile, variable-thickness profile, filet edges profile, non-contact profile, flat strip profile, variable width profile, elliptical profile, taper profile, round profile, overall shape of spring or spring in spring profile;
each of the annular wave spring elements comprises crest portion and trough portion formed alternately in a horizontal axial direction, in which the crest portion abuts the trough portion;
said crest portion and trough portion of adjacent vertically annular wave spring elements are positioned opposite each other;
said adjacent vertically annular wave spring elements have the same or different from each other in at least one physical parameter selected form a strip thickness, a strip diameter, a strip weight, strip shape, wave contact number, edge shape and a combination of wave and helical spring; and
the wave spring unit has a maximum compression up to 30.2 mm and is capable of bearing load up to 2680.2 N, when a load imposed on said annular wave spring unit and a deflection produced in said annular wave spring unit by the imposition of said load.

2. The wave spring unit according to claim 1, each of the annular wave spring elements is configured to have a thickness-diameter ratio of a thickness over a diameter ranging from 0.05 to 1.05.

3. The wave spring unit according to claim 1, which is configured to have a shaped longitudinal section of rectangular profile in the front view, have a maximum compression up to 25.6 mm and be capable of bearing load up to 124.3 N.

4. The wave spring unit according to claim 1, which is configured to have a shaped longitudinal section of variable-thickness profile in the front view, have a maximum compression up to 22.2 mm and be capable of bearing load up to 193.3 N.

5. The wave spring unit according to claim 1, which is configured to have a shaped longitudinal section of filet edges profile in the front view, have a maximum compression up to 25.6 mm and be capable of bearing load up to 103.3 N.

6. The wave spring unit according to claim 1, which is configured to have a shaped longitudinal section of non-contact profile in the front view, have a maximum compression up to 22.7 mm and be capable of bearing load up to 68.0 N.

7. The wave spring unit according to claim 1, which is configured to have a shaped longitudinal section of flat strip profile in the front view, have a maximum compression up to 30.2 mm and be capable of bearing load up to 213.5 N.

8. The wave spring unit according to claim 1, which is configured to have a shaped longitudinal section of variable-width profile in the front view, have a maximum compression up to 21.8 mm and be capable of bearing load up to 126.8 N.

9. The wave spring unit according to claim 1, which is configured to have a shaped longitudinal section of elliptical profile in the front view, have a maximum compression up to 24.5 mm and be capable of bearing load up to 273.3 N.

10. The wave spring unit according to claim 1, which is configured to have a shaped longitudinal section of taper profile in the front view, have a maximum compression up to 18.9 mm and be capable of bearing load up to 660.6 N.

11. The wave spring unit according to claim 1, which is configured to have a shaped longitudinal section of round profile in the front view, have a maximum compression up to 13.7 mm and be capable of bearing load up to 514.5 N.

12. The wave spring unit according to claim 1, which is configured to have a shaped longitudinal section of spring-in-spring profile in the front view, have a maximum compression up to 25.1 mm and be capable of bearing load up to 2680.2 N.

13. The wave spring unit according to claim 1, which is configured to have a shaped longitudinal section of rectangular profile in the front view, comprising a fillet in each corner; wherein the fillet has an inclined angle of 45° with respect to the axial direction.

14. The wave spring unit according to claim 1, wherein each of the annular wave spring elements is configured to have an identical diameter.

15. The wave spring unit according to claim 1, wherein each of the annular wave spring elements is configured to have a different diameter.

16. The wave spring unit according to claim 5, the annular wave spring unit is configured to have a maximum diameter-height ratio of a total height over a maximum diameter among the annular wave spring elements ranging from 0.2 to 0.5.

17. The wave spring unit according to claim 5, wherein the annular wave spring unit have a minimum diameter-height ratio of a total height over a minimum diameter among the annular wave spring elements ranging from 0.2 to 0.5.

18. The wave spring unit according to claim 10, wherein the annular wave-spring unit has a ratio of wire diameter over average diameter ranging from 0.01 to 0.1, in which wire diameter is the maximum diameter among all of the circular cross sections and the average diameter is calculated from each diameter of the annular wave spring elements measured along a radial direction perpendicular to the axial direction.

19. The wave spring unit according to claim 10, wherein each of the annular wave spring elements is configured to have an identical diameter.

20. The wave spring unit according to claim 10, wherein each of the annular wave spring elements is configured to have a different diameter.

21. The wave spring unit according to claim 11, the annular wave spring unit is configured to have a maximum diameter-height ratio of a total height over a maximum diameter among the annular wave spring elements ranging from 0.2 to 0.5.

22. The wave spring unit according to claim 11, wherein the annular wave spring unit have a minimum diameter-height ratio of a total height over a minimum diameter among the annular wave spring elements ranging from 0.2 to 0.5.

23. The wave spring unit according to claim 1, which is made by an additive manufacturing process.

24. The wave spring unit according to claim 3, wherein the additive manufacturing process is processed by means of at least one selected from a group consisting of selective laser melting (SLM), electron beam melting (EBM), laser metal forming (LMF), laser engineered net shape (LENS), selective laser sintering (SLS), multie jet fusion (MJF), polyjet and direct metal deposition (DMD).
